(19) United States
(12) Patent Application Publication
(10) Pub. No.: US 2003/0230998 A1
(43) Pub. Date: Dec. 18, 2003

(54) Distributed control system and distributed control method

(75) Inventors: Shin Miyaji, Hyogo (JP); Kazushige Kakutani, Osaka (JP); Shinya Kataoka, Osaka (JP); Naoto Tojo, Nara (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: SANYO ELECTRIC CO., LTD., Moriguchi-shi, Japan

(21) Appl. No.: 10/461,371

(22) Filed: Jun. 16, 2003

(30) Foreign Application Priority Data
Jun. 17, 2002 (JP) NO. 2002-175769

(51) Int. Cl. G05B 11/32

(52) U.S. Cl. 318/625

(57) ABSTRACT

A robot distributed control system includes a host controller issuing a first command and a plurality of communication controllers connected to the host controller in a tree-structured manner. The communication controller obtains a control parameter by interpreting the first command, or issues a second command by executing an application program in response to the first command and then obtains a control parameter. In either case, the control parameter is output from the communication controller to the motor controller by which a plurality of motors are controlled.

### BACKGROUND OF THE INVENTION

1. Field of the Invention

The present invention relates to a distributed control system and a distributed control method. More specifically, the present invention relates to a distributed control system and a distributed control method of a robot.

2. Description of the Prior Art

In a conventional robot distributed control system 2 shown in FIG. 14, a host controller 4a is connected with a plurality of motor drivers 4c via a hub 4b by a USB. Furthermore, each motor driver 4c is connected with a motor 6a one by one. Furthermore, the host controller 4a is also connected with a sensor board 4d to which a sensor 6b is mounted via the hub 4b. In the robot distributed control system 2, by directly issuing a motor control command to each motor driver 4c by the host controller 4a, and the motor driver 4c interprets the motor control command so as to drive the motor 6a, whereby a movement of the robot is controlled.

A same prior art similar to the prior art shown in FIG. 14 is disclosed in a Japanese Patent Laying-open No. 2000-78891 [H02P 8/14, 8/00] laid-open on Mar. 14, 2000.

In either of the prior arts, there occurs following problems. That is, each motor is controller by the host controller via the motor driver corresponding to that motor. Accordingly, in order to control respective motors, the host controller has to have control programs for all the motors, and the control commands for the motors become complex thereby to make a load of the host controller large. Furthermore, there is a necessity to send the commands to the motor drivers, and therefore, a communication load between the host controller and the motor drivers become large.

### SUMMARY OF THE INVENTION

Therefore, it is a primary object of the present invention to provide a novel distributed control system and a distributed control method.

Another object of the present invention is to provide a distributed control system and a distributed control method capable of decreasing a load of a host controller and decreasing a communication load.

A controller for distributed control according to a first invention comprises a receiver for receiving a first command from a higher controller; an outputter for outputting a control instruction to a lower controller; and a processor, wherein an application program is incorporated so as to be executable by the processor, and the processor obtains the control instruction on the basis of the first command or by use of the application program.

At this time, it is appropriate that the processor issues a second command by executing the application program in response to the first command and then obtains the control instruction on the basis of the first command or the second command.

Noted that it is appropriate that a determiner is provided and by the determiner, it is determined whether or not the second command is to be issued from the application program on the basis of the first command.

A distributed control system according to a second invention comprises a higher controller for issuing a first command by executing a first application program; a lower controller for driving an actuator; and a middle controller including a receiver for receiving the first command from the higher controller, an outputter for outputting a control instruction to the lower controller and a processor, wherein a second application program is incorporated so as to be executable by the processor, and the processor obtains the control instruction on the basis of the first command or by use of the second application program.

A distributed control system according to a third invention comprises a first controller which incorporates a first processor and a first application program therein and issues a first command on the basis of the first application program according to information or an instruction from outside; one or more second controller being connected to the first controller and incorporating a second processor and a second application program therein, the second controller obtaining a control parameter on the basis of the first command or by use of the second application program; and a third controller being connected to the second controller and for controlling a plurality of actuators on the basis of the control parameter.

At this time, it is appropriate that the second controller issues the second command by executing the second application program in response to the first command and then obtains the control parameter on the basis of the first command or the second command.

Furthermore, the second controller may be provided with a determiner for determining whether or not the second command is to be issued from the second application program on the basis of the first command.

The third controller may be further provided with a transmitter for transmitting to the second controller an identification signal of the third controller including the plurality of actuators.

Furthermore, at least one second controller to which an information input device is connected may be provided in place of the third controller.

A distributed control method according to a fourth invention is applied to a distributed control system including a first controller incorporating a first processor and a first application program, a second controller being connected to the first controller and incorporating a second processor and a second application program, and a third controller being connected to the second controller and controlling a plurality of driving devices comprises steps of (a) issuing a first command on the basis of the first application program by the first controller, (b) obtaining a control parameter by the second controller on the basis of the first command or by use of the second application program, and (c) driving the plurality of driving devices by the third controller on the basis of the control parameter.

In this case also, it is possible that in the step (b), the second controller issues the second command by executing the second application program in response to the first command and then obtains the control parameter on the basis of the first command or the second command.

The controller for distributed control according to the first invention corresponds to a communication controller in an embodiment and receives the first command from the higher controller corresponding to a host controller in the embodiment. The determiner being a determination program in an embodiment is provided, and by the determiner, it is determined whether the control instruction is directly output by interpreting the first command or the second command is to be issued from the application program on the basis of the first command. In a case the second command is issued, the control instruction is obtained on the basis of the second command. Then, the control instruction obtained by any method is applied to the lower controller controlling the actuator such as a motor.

In the distributed control system according to the second invention, the higher controller (host controller in the embodiment) issues the first command by executing the first application program. The first command is applied to the middle controller (communication controller in the embodiment). In the middle controller, the processor obtains in the same manner as a method above described the control instruction from the first command or obtains the control instruction from the second command by issuing the second command from the first command. The control instruction is applied to the lower controller for driving the actuator.

In the distributed control system according to the third invention, the first controller, the second controller and the third controller respectively corresponding to the host controller, the communication controller and the motor controller in the embodiment are utilized. The first controller issues the first command on the basis of the first application program in response to information or an instruction from outside. In the same manner as that described above, the second controller obtains the control parameter so as to be applied to the third controller.

In the distributed control system according to the fourth invention, in the step (a), the first controller issues the first command on the basis of the first application program, and in the step (b), the second controller obtains the control parameter on the basis of the first command or by use of the second application program. Then, in the step (c), the third controller drives the plurality of actuators on the basis of the control parameter.

Transferring to the middle (second) controller a part of the program incorporated in the host controller in the conventional system enables the distributed control of the plurality of actuators between the higher (first) controller and the middle (second) controller, and therefore, it is possible to not only reduce a load of the higher (first) controller but also reduce a communication load between them.

According to this invention, not only the load of the higher (first) controller but also the amount of the communication data between the higher (first) controller and middle (second) controller can be reduced, and therefore, it is possible to perform high-speed communication by two-wire line serial communication which is easy to be routed, for example.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a robot distributed control system of one embodiment of the present invention;

FIG. 2 is a block diagram showing a motion controller of FIG. 1 embodiment;

FIG. 3 is a flowchart showing an operation of the embodiment shown in FIG. 1 and FIG. 2;

FIG. 4 is an illustrative view showing one example of a command format;

FIG. 5 is an illustrative view showing one example of a shared memory included in a motor controller of the embodiment shown in FIG. 2;

FIG. 6 is a flowchart showing another example of an operation of the embodiment shown in FIG. 1 and FIG. 2;

FIG. 7 is a perspective view showing a two-wheeled inverted type transfer robot;

FIG. 8 is an illustrative view showing the two-wheeled inverted type transfer robot moving in an inclined fashion in a direction of travel;

FIG. 9 is an illustrative view showing the two-wheeled inverted type transfer robot moving in a direction of travel in an inclined fashion to the right;

FIG. 10 is a flowchart showing movement control in a host controller;

FIG. 11 is a flowchart showing movement control in a communication controller;

FIG. 12 is a flowchart showing movement control in a motor controller;

FIG. 13 is horizontally sustaining control of a table in the communication controller and the motor controller; and

FIG. 14 is a block diagram showing a conventional robot distributed process system.

### DETAILED DESCRIPTION OF THE PREFERRED EMBODIMENTS

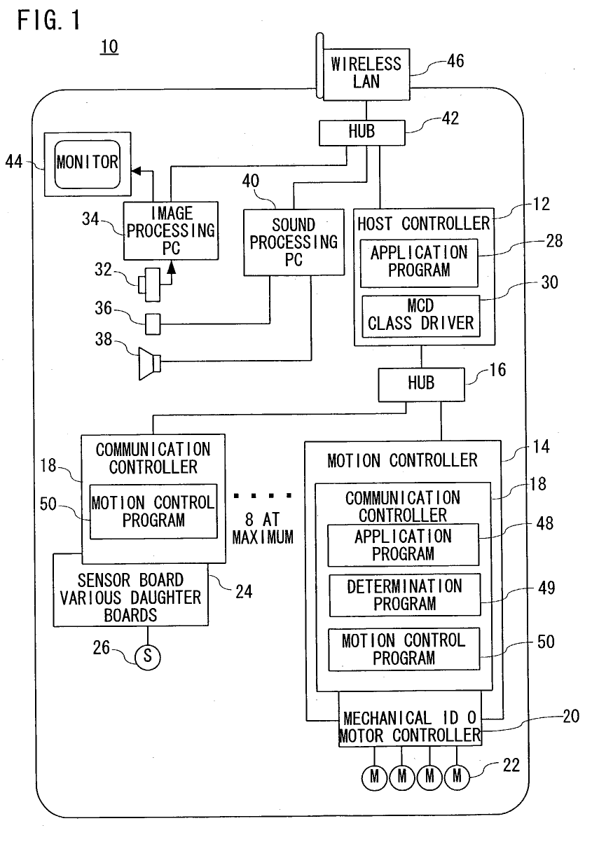

Referring to FIG. 1, a robot distributed control system 10 of this embodiment includes a one host controller 12 to which a plurality of motion controllers 14 are connected via a hub 16 by an USB such that a tree structure making the host controller 12 as a parent is established. Each motion controller 14 includes a communication controller 18 and a motor controller 20 which are connected with each other by a connector. Furthermore, each motor controller 20 is connected with a plurality of motors 22 for controlling a motion of each of axes of robot, and these motors 22 can be driven by the communication controller 18 so as to move independently or cooperatively with each other.

In such a hierarchical structure, the host controller 12 functions as a higher or a first controller, the communication controller 18 functions as a middle or a second controller, and the motor controller 20 functions as a lower or a third controller. It is noted that although the motor 22 is utilized as an actuator in this embodiment, an arbitrary device to be controlled such as an electromagnetic solenoid, pump and etc. in addition to such the motor can be contrived as an actuator to be subjected to the distributed control.

Furthermore, the hub 16 is connected with various daughter boards such as a sensor board 24 or the like mounted with a sensor 26 via the communication controller 18.

First, a description is made on the host controller 12. The host controller 12 is mounted with a general-purpose processor (not shown) and incorporates one or more application programs 28 and a motion control device class driver (hereinafter, referred to as “MCD class driver”) 30. The MCD class driver 30 incorporates various kinds of commands for controlling the motion controller 14 and an interface library for exchange information with the application program 28. In addition the application program 28 governs an entire operation of the robot and controls via the interface library an operation every motion controller 14 distributed depending on a function basis.

Furthermore, an image processing dedicated PC (Personal Computer) 34 for processing images from a stereo camera 32 and a sound processing dedicated PC 40 for processing sounds from a microphone 36 are connected to the host controller 12 via a hub 42 through Ethernet (trade mark). The host controller 12 receives as an event an image recognition result and a sound recognition result of an obstacle and so on and controls start-up or stop of the robot by exchanging information with the motion controller 14 described in detail below.

It is noted that the image processing PC 34 is connected with a monitor 44 which allows confirmation of a processed image, and the sound processing PC 40 is connected with a speaker 38 through which the robot can output a sound. In addition, the host controller 12 is connected to a network outside the robot via the hub 42 by a wireless LAN.

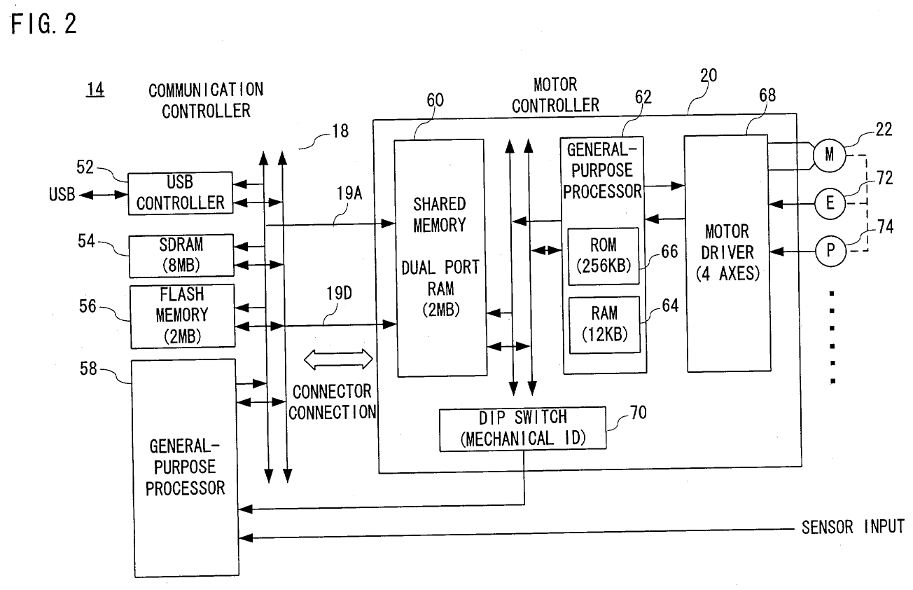

Next, a description is made on the communication controller 18 constituting the motion controller 14. The communication controller 18 is mounted with a high-performance processor 58 (FIG. 2) and therefore shares a part of function served by the host controller 12 by incorporating into the communication controller 18 a part of the plurality of application programs 28 which has conventionally been incorporated only into the host controller 12.

That is, the communication controller 18, i.e., the general-purpose processor 58 not only obtains a control parameter by interpreting a command from the host controller 12 but also obtains a control parameter by issuing a command by utilizing the application program 48 incorporated in the communication controller 18 itself. It is noted that a determination program 49 for determining whether or not the application program 48 is to be used and a motion control program 50 utilized for obtaining the control parameter by interpreting the command are incorporated in advance in a memory (e.g., a flash memory 56 in FIG. 2) of the communication controller 18.

This general-purpose processor 58 (FIG. 2) and the application program 48 make it possible to drive each of motors 22 independently or cooperatively with each other. It is noted that the number of the communication controllers 18 connectable to the host controller 12 is determined depending upon a communication protocol of the hub 16 and is 8 at the maximum in this embodiment.

Then, a description is made on the motor controller 20 constituting the motion controller 14 together with the communication controller 18. The motor controller 20 is connected to the communication controller 18 one by one and mounted with a general-purpose processor 62 (FIG. 2) and a motor driver 68 (FIG. 2). The motor driver 68 (FIG. 2) is connected with the plurality of motors 22 which are driven by a control command obtained based on the control parameter from the communication controller 18.

It is noted that an ID (identification number) can be registered for every motor controller 20 such that the host controller 12 or the communication controller 18 can identify each motor controller 20.

Furthermore, the communication controller 18 can be connected with various daughter boards such as the sensor board 24 and etc. equipped with the sensor 26. Accordingly, not only an image processing result by the image processing PC 34 and a sound processing result by the sound processing 40 but also an arbitrary sensor input can be directly input as an event to the communication controller 18 not through the host controller 12.

It is noted that although the sensor board 24 functions as an information input device for inputting information to the communication controller 18, a camera (image input device), a microphone (sound input device) and etc. can be utilized as such the information input device and, in either case, can be incorporated into the motion controller 14 by connecting the connector to the communication controller 18 in place of the motor controller 20.

Thus, by shifting a part of the plurality of application programs 28 of the robot distributed control system 10 from the host controller 12 to the communication controller 18, the control of the motor 22 can be performed by the host controller 12 and the communication controller 18 in a shared manner. Accordingly, it is possible to reduce the number of the commands issued by the host controller 12, and thus decrease a load of the host controller 12, and it is possible to reduce an amount of the communication data between the host controller 12 and the communication controller 18, and thus decrease a communication load. Accordingly, high-speed communication is realized even by two-wire line serial communication which is easy to be routed. Therefore, even if the application program 48 incorporated into the communication controller 18 is a program which must change the control parameter for the motor 22 in a short cycle, it is sufficiently adaptable.

In addition, since the communication controller 18 and the motor controller 20 are connected by a connector to each other, the motor controller 20 can be connected by being replaced with another controller 20 together with the motor 22, and the motion controller 14 can be exchanged with another motion controller 14 for every motor 22. That is, since the host controller 12 and the motion controller 14 perform the distributed control, the exchange of the motor 22, in a case the host controller 12 has an adaptable application program, is performed for every motion controller 14 while, in a case the communication controller 18 has an adaptable application program, is performed for every motor controller 20. Thus, a configuration of the robot distributed control system can be arbitrarily and easily changed.

It is noted that by connecting the communication controller 18 and the motor controller 20 with the connector, both can exchange data for each other via an address bus 19A and a data bus 19D as shown in FIG. 2.

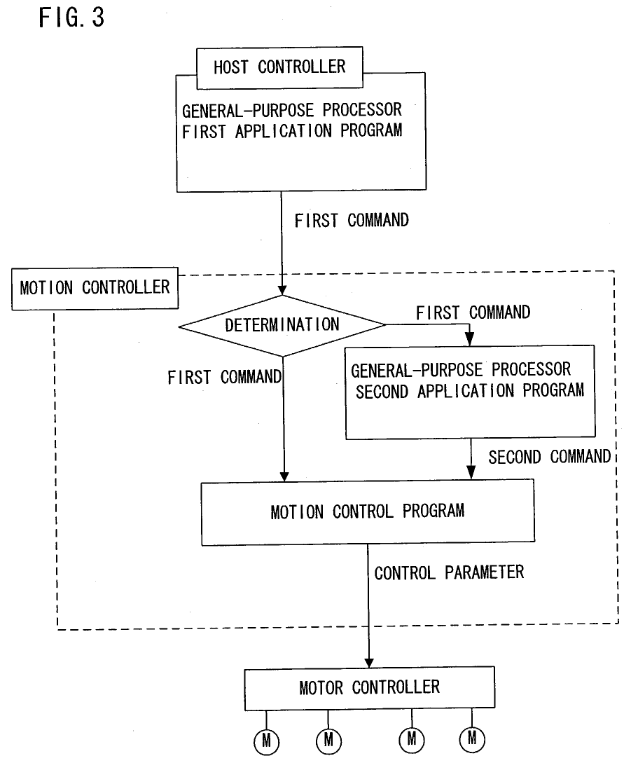

Referring to FIG. 2 and FIG. 3, a description is made on a process in the motion controller 14.

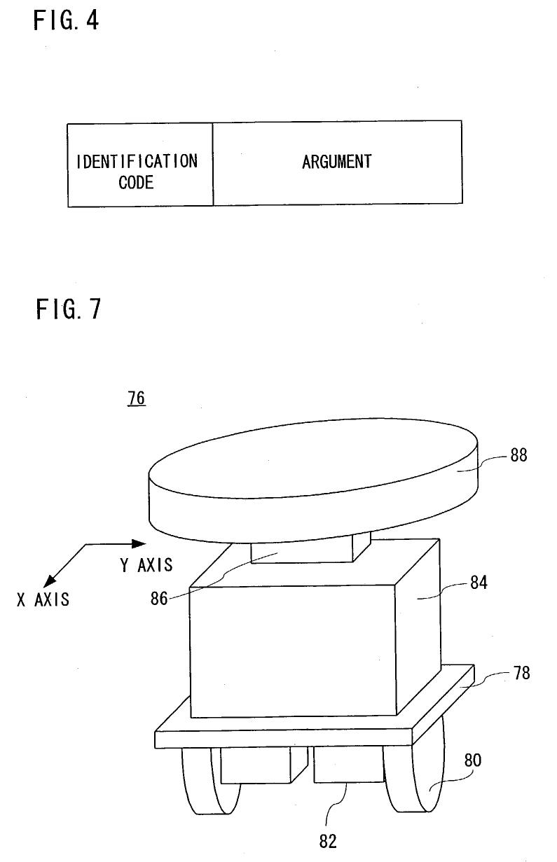

First, the host controller 12, as described above, has a general-purpose processor (not shown) and executes an application program (first application program) by the general-purpose processor. Then, the communication controller 18 receives, as a first command, a command shown in FIG. 4 sent from the host controller 12 via a USB controller 52. The command is applied with a 2-byte identification code at a head thereof and set with an argument of arbitrary number of bytes in subsequent to the identification code.

In the communication controller 18, the general-purpose processor 58 develops on an SDRAM (8 MB) 54 the determination program 49, a motion control program 50 and the application program 48 stored in the flash memory (2 MB) 56 in advance, and then starts ups the programs.

When the communication controller 18 receives the first command sent from the host controller 12 via the USB controller 52, the general-purpose processor 58 determines the identification code included in the command by use of the determination program 49 and performs a process whether the command is directly transferred to the motion control program 50 or transferred to the application program 48 depending on the determination result.

For example, the host controller 12 issues a command of “XX n1 n2 n3 n4” to the motion controller 14. Herein, “XX” is the identification code, and in a case of performing absolute position control of the motor rotation, for example, the identification code of “35” is allotted. Furthermore, in a case of performing position control of a 2-wheel-driven truck combining two motors, the identification code of “80” is allotted.

A section “n1 n2 n3 n4” subsequent to the identification code is the argument, and in a case of performing the absolute position control of the motor rotation, a rotation absolute position of the controllable 4 motors is indicated by 4-bytes data in a range from “−2147483647” to “2147483647”. A unit of the argument is the number of pulses of the encoder connected to the motor. Furthermore, n1, n2, n3 or n4=“−2147483648” indicates “Don't care”, and the command is not applied to a concerned axis. In addition, in a case of performing the position control of the 2-wheele-driven truck combining 2 motors, n1, n2, n3 and n4 indicate a moving amount of the truck, a maximum speed during moving, an acceleration up to the maximum speed, and a deceleration up to a stop, respectively.

The determination program 49 identifies the identification code included in the command and determines whether the command is to be applied to the motion control program 50 or to the application program 48. More specifically, the general-purpose processor 58 incorporates an identification code table (not shown) in which how a concerned command should be processed is registered in advance for each identification code. Accordingly, the determination program 49 determines by utilizing such the identification code table which program the command (first command) from the host controller (higher controller) is to be applied to.

For example, in a case of the identification code of “35”, the general-purpose processor 58 determines that the command is an individual motor control command through the execution of the determination program and transfers the first command to the motion control program 50. The motion control program 50 which has received the command interprets the first command, and obtains a value of the argument as an adequate motor control parameter, and sends it to the motor controller 20.

In addition, in a case of the identification code of “80”, the general-purpose processor 58 determines that the command is a cooperation command for a plurality of motors by executing the determination program 49 and transfers the command to the application program 48. The application program 48 which has received the first command as the determination result of the determination program 49 interprets the first command, issues an individual command (second command) to each motor axis, and sends it to the motion control program 50 which has already been developed on the SDRAM (8 MB) 54. The motion control program 50 which has received the second command interprets the second command, evaluates the value of the argument as the adequate motor control parameter, and sends it to the motor controller 20.

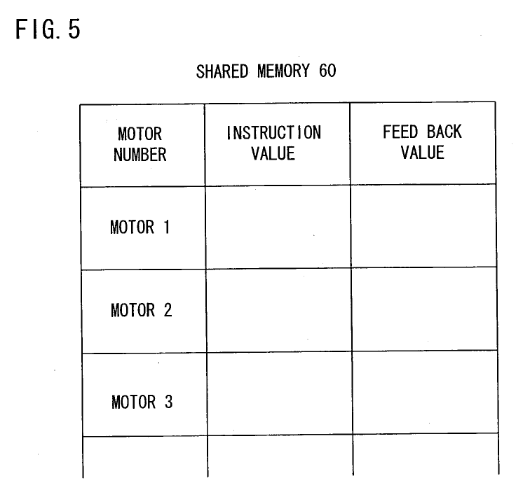

Then, the motor controller 20 is provided with a shared memory 60 as shown in FIG. 5 into which an instruction value and a feedback value are written for every motor number. The instruction value is the number of the pulses of the above-described argument. The feedback value is the number of the pulses at a time the motor is actually driven according to the instruction value. Accordingly, when the feedback value is equal to the instruction value, it is determined that the control of the motor has been completed.

Thus, the communication controller 18 included in the motion controller 14 receives the first command from the higher controller, i.e., host controller 12 and applies the first command to the motion control program 50. The motion control program 50 interprets the first command and applies the control instruction (control parameter) corresponding to the first command to the lower controller, i.e., motor controller 20. Alternatively, the communication controller 18 receives the first command from the higher controller, i.e., host controller 12, issues the second command corresponding to the first command by executing the application program (second application program), and applies the second command to the motion control program 50. The motion control program 50 interprets the second command and applies the control instruction (control parameter) to the lower controller, i.e., motor controller 20. It is noted that whether the first command is to be applied to the motion control program 50 or the application program 48 is, as described above, determined by the general-purpose processor 58 on the basis of the determination program 49.

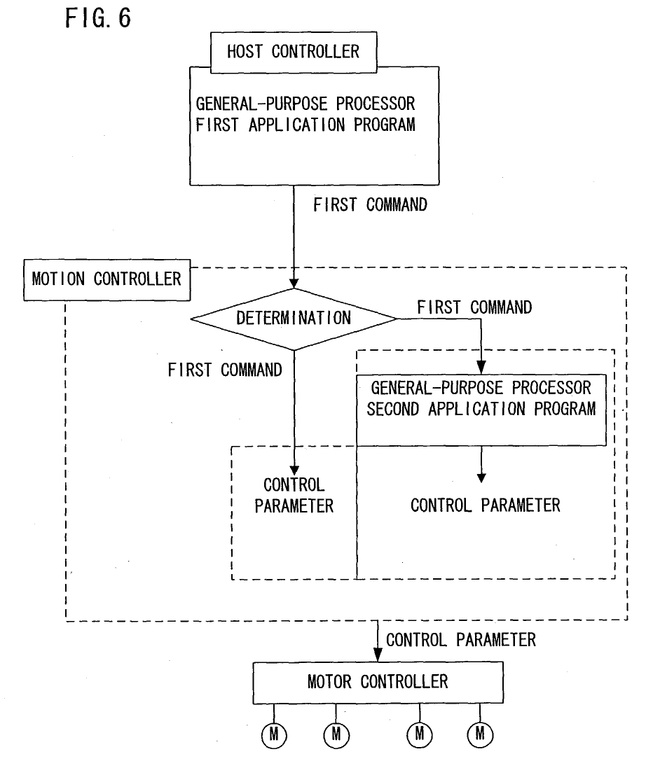

It is noted that in this case, as shown in FIG. 6, in the application program 48, it is possible that the motor control parameter is directly obtained within the application program 48 without issuing to the motion control program 50 the second command (FIG. 3) as the individual motor control command and sent to the motor control 20.

Furthermore, since the general-purpose processor 58 directly receives the input of the sensor 26 mounted on the sensor board 24 not through the host controller 12, it is possible to decrease a load of the host controller 12.

Next, a description is made on the process in the motor controller 20. The motor control parameter sent from the communication controller 18 is transferred to the general-purpose processor 62 via a dual-port RAM (2MB) being the shared memory 60. That is, as shown in FIG. 5, the instruction value is written to the shared memory 60. Furthermore, a motor control library for controlling the motor is stored in a ROM (256 KB) 66. Accordingly, the general-purpose processor 62 selects the motor control command corresponding to the motor control parameter from the motor control library, and sends it to the motor driver 68 thereby to drive the motor 22.

In addition, mechanical ID information can be set in advance by a dip (DIP) switch 70 for each motor controller 20 and transferred to the general-purpose processor 58 of the communication controller 18. The general-purpose processor 58 starts up the application program 28 of the host controller 12 or the application program 48 of the communication controller 18. Herein, the mechanical ID information is applied to the motor controller 20.

In addition, the motor driver 68 is coupled with an encoder 72 capable of measuring a relative value of the number of the rotations of the motor 22 and/or a potentiometer 74 capable of measuring an absolute value thereof. These measurement results are fed-back to the general-purpose processor 62. Then, as shown in FIG. 5, the feedback value is written to the shared memory 60. Thus, the general-purpose processor 62 determines whether or not the motor 22 rotates according to the motor control command, and determines whether or not the drive of the motor 22 should be completed.

Next, a description is made on a case that a product is carried to a destination in a state the product is loaded with stability by utilizing a 2-wheel inverted type transfer robot (hereinafter, simply referred to as “robot”) 76 shown in FIG. 7.

First, referring to FIG. 7, a description is made on the 2-wheel inverted type transfer robot 76. The robot 76 carries the product in a state the product is loaded in a stabilized manner with a table horizontally sustained irrespective of a posture of the robot 76 while being inverted with 2-wheels. The robot 76 includes a plate-shaped truck 78 to which 2 (two) wheels 80 are mounted at a lower portion. Between the wheels, the motors 22 for individually driving the respective wheels are provided in a gear box 82. In addition, on the truck 78 is provided a vehicle body 84 on which a disc-shaped table 88 is mounted via a table supporting portion 86.

In order to horizontally sustain the table 88 irrespective of a posture of the robot 76, it is necessary to adjust an angle of the table 88 by inclining the table supporting portion 86. The inclination of the table supporting portion 86 can be adjusted by rotation-driving with the motors 22 two axes (X axis and Y axis) in two directions perpendicular to the table supporting portion. As described above, the robot 76 moves with the table horizontally sustained by controlling a total number of 4 axes including 2 axes for driving the wheels 80 and 2 axes for horizontally sustaining the table 88.

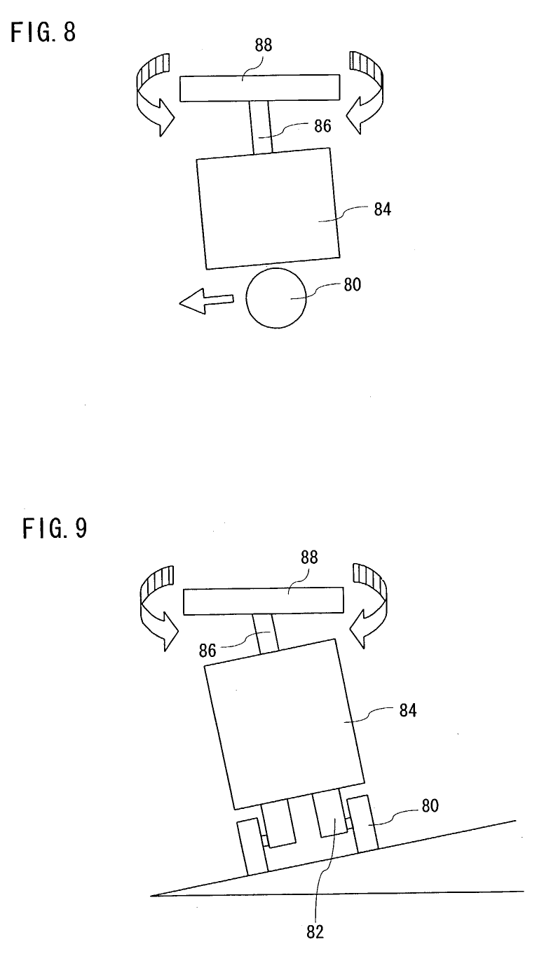

In a case the robot 76 is inclined in a travel direction as shown in FIG. 8, the table 88 is also inclined forward, and therefore, by rotationally driving the Y axis by use of the motor 22 and thereby adjusting the table supporting portion 86 so as to be inclined to a direction opposed to the travel direction, the table 88 can be horizontally sustained. Furthermore, in a case the robot 76 is inclined to the right in the travel direction as shown in FIG. 9, the table 88 is also inclined in the same manner, and therefore, by rotationally driving the X axis orthogonal to the Y axis by use of the motor 22 and thereby adjusting the table supporting portion 86 so as to be inclined to the left direction, the table 88 can be horizontally sustained.

Next, an operation from the host controller to the motor controller for every hierarchy in a case the robot 76 moves with the table 88 horizontally sustained is described by use of flowcharts. In this embodiment, moving control (inverted control) of the robot 76 is performed by the host controller 12, and horizontal sustaining control of the table 88 is performed by the communication controller 18.

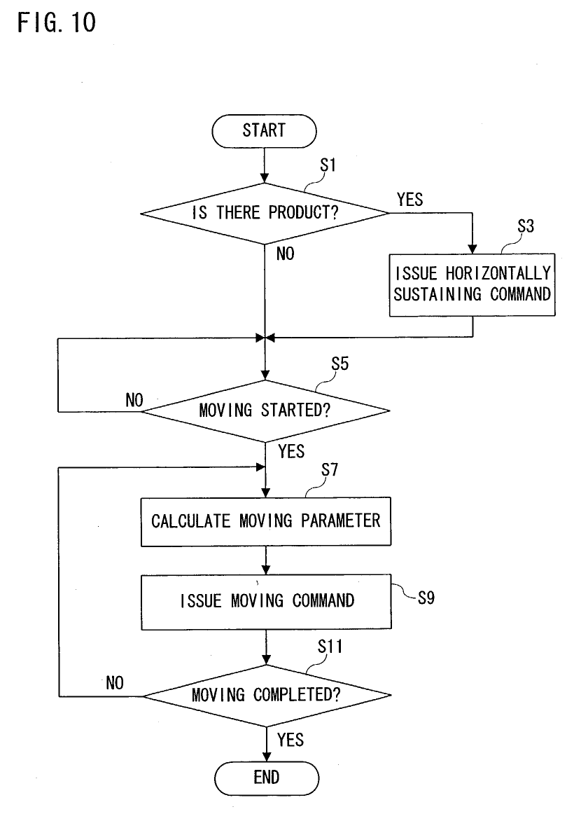

First, a description is made on the moving control in the host controller 12 with reference to FIG. 10 flowchart.

First, it is determined whether or not the robot 76 has the product in a step S1. Herein, whether or not the product is present is determined by, for example, the weight sensor 26 mounted on the sensor board 24 of the robot 76 or information from another PC such as the image processing PC 34 and etc.

Then, in a case there is the product, a horizontal sustaining command is issued to the communication controller 18 in a step S3. If the horizontal sustaining command is issued, the communication controller 18 performs the horizontally sustaining control independent of the host controller 12 from this time on.

Next, it is determined whether or not a moving start is triggered with respect to the robot 76 according to a sound or voice instruction processed by the sound processing PC 40 in a step S5. As another example of the trigger, there is an instruction by a person from outside the robot 70.

In a step S7, moving parameters such as moving distance, direction, speed and etc. of the robot 76 are calculated by the application program 28 on the basis of an environment recognition result by the image processing PC 34. Alternatively, these parameters may be applied by a person from the outside the robot 76 via a user interface.

In a step S9, the moving parameters obtained in the step S7 are issued as a moving command to the motion controller 14 by the application program 18.

In a step S11, it is determined whether or not the movement of the robot 76 has been completed, and in a case the movement has not been completed, the moving parameters are calculated again in the step S7 so as to issue the moving command. Furthermore, if the movement has been completed, the process in the host controller 12 is completed. It is noted that whether or not the movement has been completed is performed on the basis of the image recognition result and etc. from the image processing PC 34.

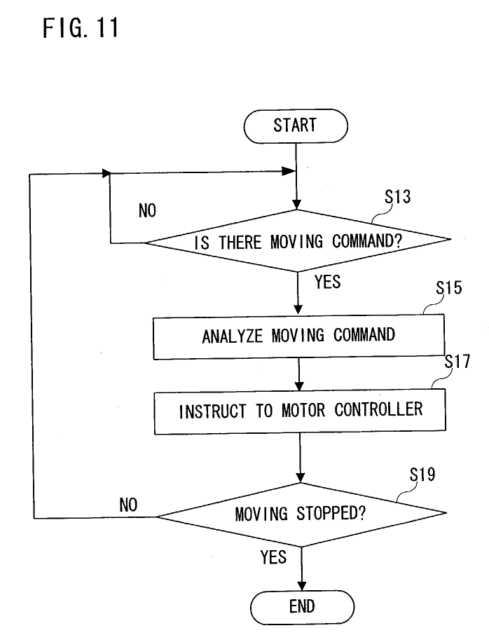

Then, a description is made on the moving control of the robot 76 in the communication controller 18 with referring to FIG. 11 flowchart.

First, it is determined whether or not the moving command is issued form the host controller 12 to the communication controller 18 in a step S13. The moving command is transmitted by a USB communication interruption.

Next, in a step S15, the moving command from the host controller 12 is analyzed on the basis of the motion control program 50. That is, the motor control parameters such as rotation of direction, rotation speed, amount of rotation and etc. of the motor 22 are obtained from the moving parameters such as distance, direction, speed and etc.

In a step S17, the motor control parameters obtained in the step S15 are applied to the motor controller 20.

In a step S19, the process returns to the step S13 so long as an instruction of stop moving is not input from the host controller 12, and waits the moving command from the host controller 12.

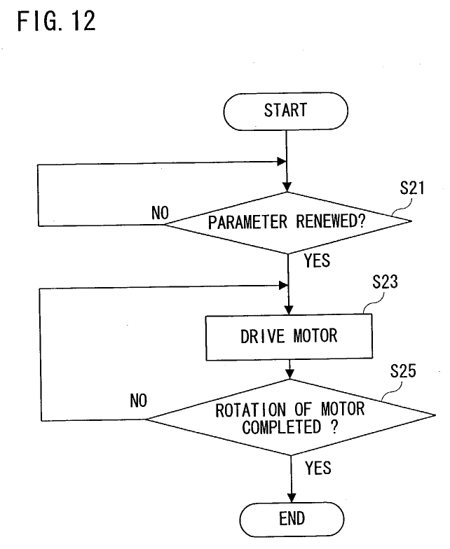

Next, a description is made on the moving control in the motor controller 20 with referring to FIG. 12 flowchart.

First, in a step S21, it is determined whether or not the motor control parameters such as rotation of direction, rotation speed, amount of rotation and etc. of the motor 22 sent from the communication controller 18 in the step S17 were renewed ones.

Then, if renewed, the motor 22 is driven by issuing the motor control command to the motor driver 68 on the basis of the renewed motor control parameters in a step S23.

In a step S25, it is determined whether or not the motor 22 is rotated according to the rotation of direction, the speed and the amount of the rotation specified by the motor control parameters on the basis of measured values of the encoder 72 or the potentiometer 74. Consequently, in a case the rotation of the motor 22 is not completed, the process returns to the step S23 again so as to continue driving the motor 22, and in a case the rotation is completed, the driving of the motor 22 is completed.

According to the above-described process from the host controller 12 to the motor controller 20, it is possible to control the movement of the robot 76.

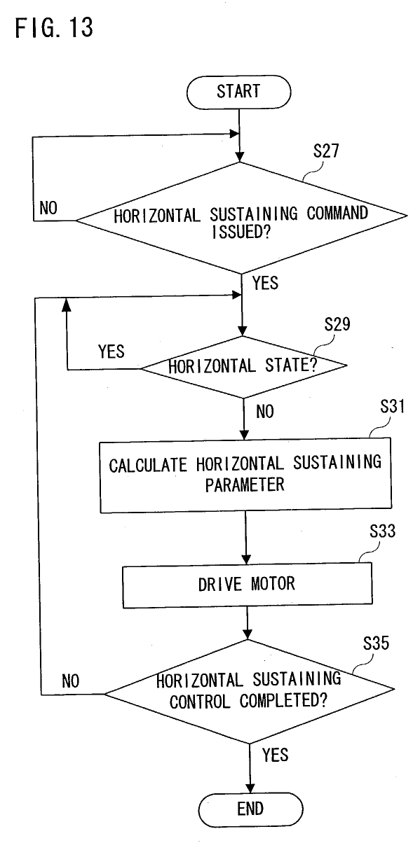

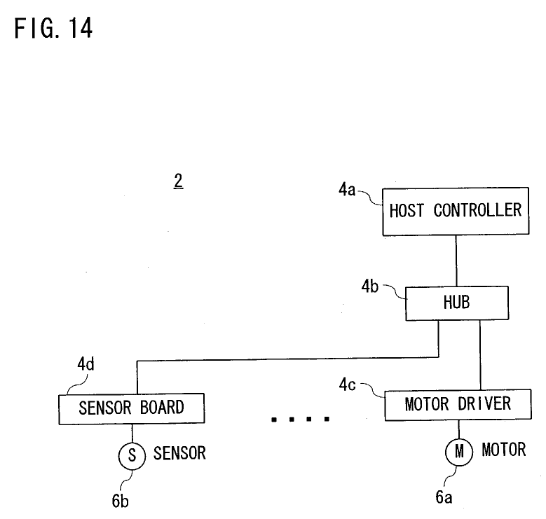

Next, a description is made on the horizontally sustaining control by the motion controller 14 with referring to FIG. 13 flowchart.

First, in a step S27, it is confirmed whether or not the horizontally sustaining command is issued by the host controller 12 in the step S3.

Then, in a case the horizontally sustaining command is issued, it is determined whether or not the table 88 of the robot 76 is horizontal in a step S29. A measured value of the sensor 26 such as gyroscopic sensor, tilt sensor and etc. provided in the sensor board 24 connected to the determination controller 18 is directly input to the general-purpose processor 58, and whereby the determination is performed on the basis of the measured value by the general-purpose processor 58.

Next, in a case the table 88 is not horizontal, horizontally sustaining parameters such as tilt angle, tilt direction of the table 88 and etc. are calculated by use of the application program 48 incorporated in the flash memory 56 of the communication controller 18 in a step S31. Furthermore, the motor control parameters such as rotation of direction, speed, amount of direction and etc. of the motor 22 for rotationally driving the X axis and the Y axis in order to control the tilt of the table supporting portion 86 are obtained and applied to the motor controller 20.

In a step S33, the motor controller 20 drives the motor 22 on the basis of the motor control parameters sent from the communication controller 18 and thereby to rotate the X axis or the Y axis for adjusting the tilt of the table supporting portion 86 resulting in capable of horizontally sustaining the table 88.

Next, it is determined whether or not the horizontally sustaining control of the table 88 of the robot 76 is stopped in a step S35. If the horizontally sustaining control is continued, the process is returned to the process so as to determine whether or not the table 88 is horizontal again in the step S29, and if stopped, the horizontally sustaining operation is completed. A stop instruction of the horizontally sustaining control is performed by transmitting to the host controller 12 the information relating to the product from the image processing PC 34 and etc. and then issuing to the communication controller 18 an interruption command for stopping the horizontally sustaining control from the host controller 20 on the basis of the information.

The horizontally sustaining of the table 88 can be controlled by the processes in the above-described communication controller 18 and the motor controller 20.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A controller for distributed control, comprising:
a receiver for receiving a first command from a higher controller;
an outputter for outputting a control instruction to a lower controller; and
a processor, wherein
an application program is incorporated so as to be executable by said processor and
said processor obtains the control instruction on the basis of the first command or by use of the application program.

2. A controller for distributed control according to claim 1, wherein said processor issues a second command by executing the application program in response to the first command and obtains the control instruction on the basis of the first command or the second command.

3. A controller for distributed control according to claim 2, further comprising a determiner for determining whether the second command is to be issued from the application program on the basis of the first command.

4. A distributed control system, comprising:
a higher controller for issuing a first command by executing a first application program;
a lower controller for driving an actuator; and
a middle controller including a receiver for receiving the first command from said higher controller, an outputter for outputting a control instruction to said lower controller and a processor, wherein a second application program is incorporated so as to be executable by said processor, and said processor obtains the control instruction on the basis of the first command or by use of the second application program.

5. A distributed control system, comprising:
a first controller which incorporates a first processor and a first application program therein and issues a first command on the basis of the first application program according to information or an instruction from outside;
one or more second controller being connected to said first controller and incorporating a second processor and a second application program therein, said second controller obtaining a control parameter on the basis of the first command or by use of the second application program; and
a third controller being connected to said second controller for controlling a plurality of actuators on the basis of the control parameter.

6. A distributed control system according to claim 5, wherein said second controller issues a second command by executing the second application program in response to the first command and obtains the control parameter on the basis of the first command or the second command.

7. A distributed control system according to claim 6, wherein said second controller further includes a determiner for determining whether or not the second command is to be issued from the second application program on the basis of the first command.

8. A distributed control system according to claim 5 or 7, wherein said third controller further includes a transmitter for transmitting to said second controller an identification signal of said third controller including the plurality of actuators.

9. A distributed control system according to claim 5 or 8, further comprising at least one said second controller to which an information input device is connected in place of said third controller.

10. A control method of a distributed control system including a first controller incorporating a first processor and a first application program, a second controller being connected to said first controller and incorporating a second processor and a second application program, and a third controller being connected to said second controller and controlling a plurality of driving devices, including steps of:
(a) issuing a first command by said first controller on the basis of the first application program;
(b) obtaining a control parameter by said second controller on the basis of the first command or by use of the second application program; and
(c) driving the plurality of driving devices by said third controller on the basis of the control parameter.

11. A method of a distributed control according to claim 10, wherein in said step (b), said second controller issues a second command by executing the second application program in response to the first command and obtains the control parameter on the basis of the first command or the second command.
